(19) United States
(12) Patent Application Publication
(10) Pub. No.: US 2026/0102224 A1
(43) Pub. Date: Apr. 16, 2026

(54) COMPOSITIONS AND METHODS FOR ADDITIVE MANUFACTURING OF PALATAL EXPANDERS

(71) Applicant: Align Technology, Inc., San Jose, CA (US)

(72) Inventors: Congqi Yan, San Jose, CA (US); Paramjot Singh, San Jose, CA (US); Chunhua Li, Cupertino, CA (US); Yan Chen, Cupertino, CA (US)

(21) Appl. No.: 19/355,358

(22) Filed: Oct. 10, 2025

Related U.S. Application Data
(60) Provisional application No. 63/706,287, filed on Oct. 11, 2024.
(60) Provisional application No. 63/824,681, filed on Jun. 16, 2025.

(51) Int. Cl. A61C 7/10; B33Y 10/00; B33Y 40/10

(52) U.S. Cl. CPC A61C 7/10; B33Y 10/00; B33Y 40/10

(57) ABSTRACT

Materials, methods, and systems for additive manufacturing are provided. In some embodiments, a method includes: forming a mixture including a first thermoplastic polymer powder separated from a first additively manufactured dental appliance manufactured during a first powder bed fusion process, where the first thermoplastic polymer powder has a characteristic particle size distribution and a characteristic melt volume rate; in a second powder bed fusion process, depositing a powder layer of the mixture, where the powder layer has a powder packing consistency dependent on the characteristic particle size distribution of the first thermoplastic polymer powder; and in the second powder bed fusion process, applying energy to the powder layer to melt the powder layer to form a part layer of a second additively manufactured dental appliance, where the part layer has a material consistency dependent on the characteristic melt volume rate of the first thermoplastic polymer powder.

### CROSS-REFERENCE TO RELATED APPLICATION(S)

The present application claims the benefit of priority to U.S. Provisional Application No. 63/706,287, filed Oct. 11, 2024, and U.S. Provisional Application No. 63/824,681, filed Jun. 16, 2025, each of which is incorporated by reference herein in its entirety.

### TECHNICAL FIELD

The present technology generally relates to orthodontics, and in particular, to compositions and methods for additive manufacturing of palatal expanders.

### BACKGROUND

Dental appliances are used to treat various dental conditions, such as dental malocclusions, jaw dysfunction/misalignment, functional and/or aesthetic conditions, endodontic conditions, and others. For example, palatal expansion devices may be used to expand the roof of a patient's mouth and widen the patient's upper jaw to address conditions such as crossbite, crowding, or impacted teeth. Conventional non-removable palatal expansion devices typically use a jackscrew-type mechanism that delivers horizontal forces to the patient's molars to split the upper jaw along the mid-palatal suture. Such devices may interfere with the patient's speech and eating, may cause significant pain due to the large forces involved, and may not be aesthetically pleasing to wear. Patient-removable palatal expansion devices can address some of these concerns, but improvements to the properties and manufacturing processes for such devices are still needed.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a perspective view of a palatal expander configured in accordance with embodiments of the present technology.

FIG. 1B is a bottom view of an upper dental arch of a patient including dental auxiliaries, in accordance with embodiments of the present technology.

FIG. 1C illustrates the palatal expander of FIG. 1A on the dental arch of FIG. 1B, in accordance with embodiments of the present technology.

FIG. 2 is a flow diagram of a method for fabricating and post-processing an additively manufactured object, in accordance with embodiments of the present technology.

FIG. 3A is a partially schematic diagram of a system for additive manufacturing, in accordance with embodiments of the present technology.

FIG. 3B is a partially schematic diagram of an object in a powder cake produced by the system of FIG. 3A, in accordance with embodiments of the present technology.

FIG. 3C is a partially schematic diagram of the object of FIG. 3B after cleaning, in accordance with embodiments of the present technology.

FIG. 4 is a flow diagram illustrating a method for fabricating an additively manufactured palatal expander, in accordance with embodiments of the present technology.

FIG. 5A illustrates a representative example of a tooth repositioning appliance configured in accordance with embodiments of the present technology.

FIG. 5B illustrates a tooth repositioning system including a plurality of appliances, in accordance with embodiments of the present technology.

FIG. 5C illustrates a method of orthodontic treatment using a plurality of appliances, in accordance with embodiments of the present technology.

FIG. 6 illustrates a method for designing an orthodontic appliance, in accordance with embodiments of the present technology.

FIG. 7 illustrates a method for digitally planning an orthodontic treatment and/or design or fabrication of an appliance, in accordance with embodiments of the present technology.

### DETAILED DESCRIPTION

The present technology relates to materials, methods, and systems for additive manufacturing of dental appliances, such as palatal expanders. In some embodiments, for example, a method includes fabricating an additively manufactured palatal expander from a thermoplastic polymer powder via a powder bed fusion process (e.g., selective laser sintering). The thermoplastic polymer powder can have a characteristic powder size distribution, such as a D90 value within a range from 70 μm to 150 μm, a D50 value within a range from 45 μm to 70 μm, and/or a D10 value within a range from 20 μm to 45 μm. The thermoplastic polymer powder can also have a characteristic melt volume rate, such as a melt volume rate within a range from 30 cm³/10 min to 150 cm³/10 min. The method can include separating the additively manufactured palatal expander from remaining thermoplastic polymer powder. The method can further include mixing at least some of the remaining thermoplastic polymer powder with fresh thermoplastic polymer powder, and using the mixture in a subsequent powder bed fusion process.

The present technology can provide many advantages compared to conventional approaches for additive manufacturing of dental appliances and other objects. For instance, the additive manufacturing methods described herein use a thermoplastic polymer powder that may be reused (e.g., 1X, 2X, etc., or an unlimited number of times), in contrast to conventional methods which require that the powder be discarded after a single use or a few uses. This can be particularly advantageous to reduce costs for industrial-scale production of additively manufactured objects. Moreover, the properties of the thermoplastic polymer powder can be selected to produce a high degree of accuracy and consistency in fabrication (e.g., good powder packing consistency and material consistency), while also ensuring that the resulting fabricated object has satisfactory functional properties (e.g., sufficient modulus and strength to expand a patient's palate, and sufficient durability to withstand extended wear in the oral environment). For example, for industrial-scale production, it may be desirable to increase the density of objects fabricated on the same powder bed to maximize the number of objects that may be printed concurrently; fabrication consistency may be important to ensure that the resulting objects are satisfactory regardless of their location on the powder bed (e.g., corners/edges versus the center of the bed). The advantages of the materials and methods described herein include a reduction in overall material costs and material wastage, and a more stable manufacturing workflow.

In some embodiments, the mixing of used thermoplastic polymer powder from a prior additive manufacturing process with new thermoplastic polymer powder, where the used and/or new powder have characteristic particle size distributions, melt volume rates, and/or other physical properties, can address important technical issues involved in additively manufactured mass customized medical devices, including mass customized dental appliances.

Existing processes to manufacture dental appliances may waste significant materials of material. In the case of additively manufactured dental appliances, the materials used in the additive manufacturing process can be rare, expensive, hard to source, etc. When printing a series of incremental dental appliances, e.g., those that make incremental and/or sequential changes to dentition, existing manufacturing processes may waste material that could otherwise be reused for the same and/or similar cases. As an example, for dental appliances that are additively manufactured using a stereolithography (SLA) or a digital light processing (DLP) process, uncured resin that is not reused may be wasted. As another example, in a powder bed fusion process (e.g., a selective laser sintering (SLS) process), unfused thermoplastic polymer materials (e.g., unfused thermoplastic polymer powder) that are not reused may be wasted.

Processes for fabricating additively manufactured aligners, other orthodontic appliances that are shaped to perform incremental changes on dentition, retainers, attachment placement devices, etc., may waste material if uncured and/or unfused materials are not reused. Additive manufacturing processes to print incremental palatal expanders and/or a series of incremental palatal expanders used to expand a person's palate from an initial position toward a target position in accordance with one or more aspects of a treatment plan may waste material if uncured and/or unfused materials are not reused.

Conventionally, unfused thermoplastic polymer powder in powder bed fusion processes is not reused. Suppliers typically do not qualify unfused thermoplastic polymer powder for reuse in subsequent print processes because of material property degradation. After being used in a prior print process and/or removed from a printed item, unfused thermoplastic polymer powder usually does not deliver sufficient powder packing consistency, printed material consistency, and/or other physical properties to make a subsequent printed part.

One issue is that the particle size distribution of conventional thermoplastic polymer powder may not allow the powder to be packed consistently in a subsequently printed object. “Particle size distribution,” as used herein, can include one or more values to describe proportions of particles of different sizes within a material. Powder packing consistency can impact the density, mechanical properties, and/or surface finish of an additively manufactured object. The techniques herein can ensure even repeatable powder layers, uniform heating and melting, and/or optimized build quality. As noted herein, the powder packing consistency may improve:
Porosity: Local variations in packing density can cause areas with less material to become porous or contain unfused regions, negatively impacting the object's strength and fatigue performance.
Surface quality: Non-uniform layers can cause irregularities in the melt pool during the fusion process, which can result in surface defects like “balling” and a rough finish.
Thermal transfer: The packing density of the powder bed affects its thermal properties. Inconsistent packing can lead to non-uniform heat transfer, causing different parts of the powder bed to melt unevenly.
Microstructure: Since packing consistency influences the melt and solidification processes, it can affect the object's final microstructure, which may influence properties like corrosion resistance, ductility, and toughness.

Another issue is that thermal properties (e.g., melt volume properties such as melt volume rate) of conventional thermoplastic polymer powder may not deliver an acceptable material consistency to form a subsequent printed object. “Melt volume properties,” as used herein, may include how a material's volume changes when it melts and while it is in the molten state. “Melt volume rate,” as used herein, may include a measure of a volume of a thermoplastic polymer that flows through a specific space over a specific period, and can indicate a polymer's processability and its flow characteristics when in a molten state. The techniques herein can ensure acceptable material consistencies due to melt volume properties and/or other thermal properties of the materials described herein.

The solutions herein can improve the manufacturing efficiency of mass customized medical devices, such as mass customized dental appliances. For example, the solutions herein allow for fabrication of additively manufactured aligners, other orthodontic appliances that are shaped to perform incremental changes on dentition, retainers, attachment placement devices, etc., that may require uniform print layer thicknesses, smooth surface finishes, and/or other physical properties that allow them to perform their intended functions. As another example, the solutions herein enable additive manufacturing of incremental palatal expanders, particularly those customized to a person's dental and/or palatal anatomy, that may require uniform print layer thicknesses, smooth surface finishes, etc., to fit into a person's mouth, expand their palate, and remain comfortable, particularly during predicted stages of expansion (e.g., stages of expansion that are predicted by treatment planning software but were not captured through an intraoral capture device, such as a scanner, impressions, x-ray, etc.).

The solutions herein may be used to efficiently fabricate incremental medical devices, such as dental appliances that modify dentition in an incremental manner. To continue the foregoing examples, additively manufactured aligners, other orthodontic appliances that are shaped to perform incremental changes on dentition, retainers, attachment placement devices, etc., may include a subsequent appliance in a series of appliances made of the same or similar resin, etc., as a prior appliance. Similarly, incremental palatal expanders may include a subsequent appliance in a series of appliances made of the same or similar thermoplastic polymer powder as a prior appliance. As many medical devices and/or dental appliances are regulated devices, material consistency may be important to ensure that specific medical device and/or dental appliance technologies are feasible. Material reuse in a way that meets device specifications may be a critical factor to manufacturability, effective design, and/or the ability to bring products to market.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Additively Manufactured Palatal Expanders

The present technology provides compositions and methods for fabricating dental appliances for palatal expansion treatment. In some embodiments, a patient's palate is expanded using a series of removable dental appliances. The removable dental appliances can be sequentially applied to the patient's teeth to incrementally adjust a geometry (e.g., width) of the palate. For instance, the removable dental appliances can include a series of palatal expanders configured to adjust the palate from an initial geometry (e.g., an initial width) to a target geometry (e.g., a target width) according to a plurality of treatment stages of a treatment plan.

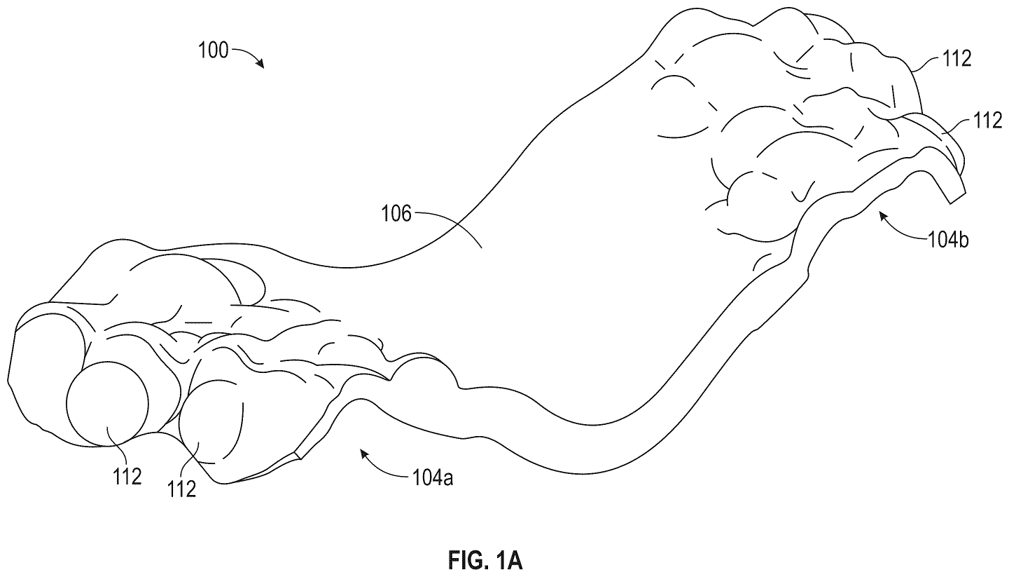

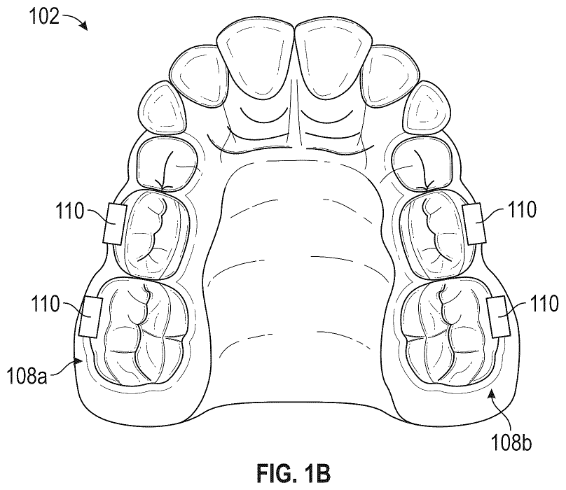

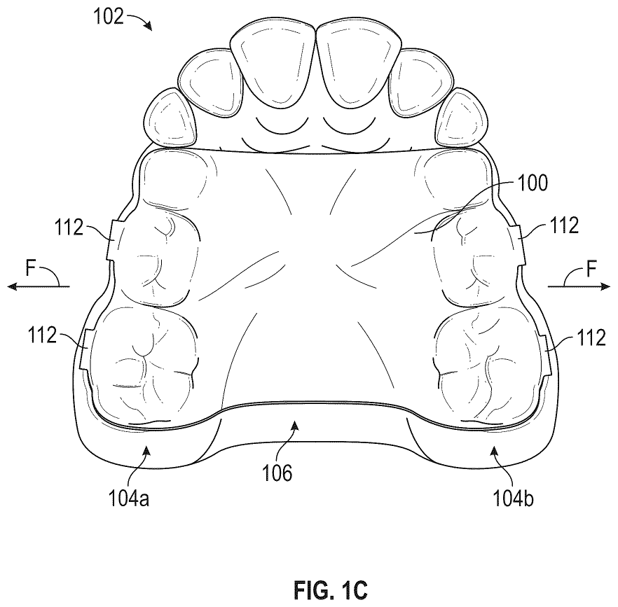

FIGS. 1A-IC illustrate a dental system for expanding a patient's palate, in accordance with embodiments of the present technology. Specifically, FIG. 1A is a perspective view of a palatal expander 100, FIG. 1B is a bottom view of an upper dental arch 102 of a patient, and FIG. 1C illustrates the palatal expander 100 on the dental arch 102. The palatal expander 100 can be a polymeric dental appliance including a first tooth engagement portion 104a, a second tooth engagement portion 104b, and a palatal portion 106 between the first tooth engagement portion 104a and the second tooth engagement portion 104b. As best seen in FIGS. 1B and 1C, the first tooth engagement portion 104a is configured to receive one or more first teeth 108a at a first side of the dental arch 102, and the second tooth engagement portion 104b is configured to receive one or more second teeth 108b at a second, opposite side of the dental arch 102. The first teeth 108a and the second teeth 108b received by the first tooth engagement portion 104a and the second tooth engagement portion 104b, respectively, can include some or all of the posterior teeth, such as one or more molars and/or premolars. For example, the first teeth 108a and the second teeth 108b can be the three distalmost teeth on each side of the dental arch 102.

In the illustrated embodiment, the first tooth engagement portion 104a and the second tooth engagement portion 104b each include a set of cavities formed therein to receive the first teeth 108a and the second teeth 108b, respectively. An individual cavity may receive a tooth by, for example, receiving and/or extending over only a portion of the tooth, such as the crown of the tooth, a portion of the tooth proximate to the crown, a buccal surface of the tooth, a lingual surface of the tooth, etc. The interior surfaces of the cavity can conform to the occlusal, lingual, and/or buccal surfaces of the received tooth.

The palatal portion 106 is positioned between the first tooth engagement portion 104a and the second tooth engagement portion 104b to couple these components to each other. When the palatal expander 100 is worn on the dental arch 102, the palatal portion 106 can be positioned proximate to the palate of the patient (e.g., spaced apart from some or all of the palatal surface, or in direct contact with some or all of the palatal surface). The palatal portion 106 can be configured to apply forces to the first tooth engagement portion 104a and the second tooth engagement portion 104b that are transmitted to the first teeth 108a and the second teeth 108b, respectively, to cause expansion of the patient's palate. In some embodiments, the width of the palatal portion 106 is greater than the width of the dental arch 102 when the palatal expander 100 is worn on the patient's teeth, and the stiffness of the palatal portion 106 (e.g., which may vary according to the thickness and material properties of the palatal portion 106) is sufficiently high to generate and maintain a sufficient amount of force to cause expansion of the palate. The forces produced by the palatal portion 106 can be generally directed in a horizontal, outward (buccal) direction, e.g., as indicated by arrows F in FIG. 1C. The magnitude of the forces for effective palatal expansion may be significantly greater than those typically needed for other types of dental/orthodontic treatment procedures. For instance, the forces can be at least 10 N, 20 N, 30 N, 40 N, 50 N, or 60 N; and/or within a range from 9 N to 20 N, 20 N to 60 N, or from 40 N to 60 N.

Referring to FIGS. 1B and 1C, in some embodiments, the palatal expander 100 is used in combination with one or more dental auxiliaries 110 that are coupled to one or more teeth of the dental arch 102 to engage the palatal expander 100, such as the first tooth engagement portion 104a and/or the second tooth engagement portion 104b. For example, the dental auxiliaries 110 can be dental attachments (e.g., prefabricated attachments or attachments formed in situ) that are bonded to the surfaces of the patient's teeth. Other types of dental auxiliaries 110 that may be used include buttons, brackets, pins, connectors, wires, etc. The engagement between the dental auxiliaries 110 and the palatal expander 100 can serve various purposes, such as facilitating retention of the palatal expander 100 on the dental arch, improving transfer of expansion forces from the palatal expander 100 to the underlying teeth, and/or counteracting undesirable tooth movements that might otherwise occur due to expansion forces (e.g., tipping).

The geometry of the dental auxiliaries 110 can be configured to produce secure engagement with the palatal expander 100, while avoiding excessively large forces during placement of the palatal expander 100 on the dental arch 102 and/or removal of the palatal expander 100 from the dental arch 102. The dental auxiliaries 110 can each independently have any suitable shape, such as a polyhedral shape (e.g., cuboidal or other prismatic shape with flattened polygonal surfaces), a rounded shape (e.g., ellipsoidal, spherical, or other shape with rounded surfaces), or suitable combinations thereof (e.g., a first surface of a dental auxiliary 110 can be rounded and a second surface of the dental auxiliary 110 can be flattened).

The number and configuration of the dental auxiliaries 110 on the dental arch 102 can be varied as desired. For example, although the illustrated embodiment shows four dental auxiliaries 110 (e.g., two dental auxiliaries 110 on the first teeth 108a and two dental auxiliaries 110 on the second teeth 108b), in other embodiments, a different number of dental auxiliaries 110 can be used, such as one, two, three, five, six, seven, eight, or more dental auxiliaries 110. In some embodiments, multiple attachments may be placed on a single tooth. For example, two or three attachments (e.g., buccal attachments) may be placed on the terminal molar (e.g., the most distal molar of the patient) for balancing loads and providing increased retention. These attachments may be smaller in size relative to other attachments to enable placement on a single tooth. Moreover, although the dental auxiliaries 110 are depicted as being placed on the two distalmost teeth on each side of the dental arch 102, the dental auxiliaries 110 can alternatively or additionally be placed on any other teeth received by the palatal expander 100, either the first side or the second side of the dental arch 102 may not include any dental auxiliaries, etc. The geometry (e.g., shape, dimensions) of each dental auxiliary 110 can independently be varied as desired, e.g., some or all of the dental auxiliaries 110 may have different shapes, or some or all of the dental auxiliaries 110 can have the same shape.

In some embodiments, the palatal expander 100 includes one or more receptacles 112 (e.g., recesses, apertures, indentations, pockets) to receive and engage the dental auxiliaries 110. For example, the first tooth engagement portion 104a can include one or more first receptacles 112 formed therein to receive one or more dental auxiliaries 110 on the first teeth 108a, and/or the second tooth engagement portion 104b can include one or more second receptacles 112 formed therein to receive one or more dental auxiliaries 110 on the second teeth 108b. Each receptacle 112 can be formed in a sidewall of a cavity for a tooth having the corresponding dental auxiliary 110, such that when the tooth is received within the cavity, the dental auxiliary 110 on the tooth is positioned partially or entirely within the receptacle 112. The interior surface of the receptacle 112 can conform partially or entirely to the exterior surface of the received dental auxiliary 110 to provide mating engagement between the receptacle 112 and the dental auxiliary 110.

The number, geometry, and locations of the receptacles 112 in the palatal expander 100 can correspond to the number, geometry, and locations of the dental auxiliaries 110 on the dental arch 102. In the illustrated embodiment, for example, the palatal expander 100 includes four receptacles 112 at the buccal surface of the first tooth engagement portion 104a and the second tooth engagement portion 104b to receive the four dental auxiliaries 110 on the buccal surfaces of first teeth 108a and the second teeth 108b, respectively. In other embodiments, however, some or all of the receptacles 112 can be configured differently depending on the configuration of the corresponding dental auxiliaries 110, e.g., the palatal expander 100 can include fewer or more receptacles 112, etc.

The palatal expander 100 can be one of a series of palatal expanders configured to incrementally expand the patient's palate from a first width toward a second width in a plurality of treatment stages. Each palatal expander in the series can be generally similar to the palatal expander 100 shown in FIGS. 1A-1C, but the design of the palatal expander can be customized to the particular treatment stage. For instance, different palatal expanders in the series can have palatal portions 106 with different geometries (e.g., widths, thicknesses) and/or different material properties, depending on the amount of expansion to be achieved during the corresponding treatment stage. Some or all of the palatal expanders in the series can be configured for use with the same dental auxiliaries 110 (e.g., some or all of the dental auxiliaries 110 can remain on the dental arch 102 across multiple treatment stages), or some or all of the palatal expanders in the series can be configured for use with different dental auxiliaries 110 (e.g., some or all of the dental auxiliaries 110 may be removed and/or replaced with other dental auxiliaries 110 for different treatment stages).

In some embodiments, a palatal retainer (also known as a “palatal holder”) may be worn by a patient to maintain the patient's palate at a target width (e.g., the target width to be achieved by a palatal expansion treatment plan). The palatal retainer can be generally similar to the palatal expander 100 and can include any of the features shown in FIGS. 1A-IC, except that the forces applied by the palatal retainer are configured to maintain a current width of the palate rather than to expand the width of the palate. A palatal retainer may be worn during any stage of a palatal expansion treatment plan, such as after the patient's palate has been expanded to a target width by a series of palatal expanders. In such embodiments, the palatal retainer may have the same or similar geometry as the final palatal expander of the treatment plan. Any reference herein to a “palatal expander” may encompass appliances for expansion of the palate as well as appliances for maintaining a palate in a current width.

### A. Materials for Additive Manufacturing of Palatal Expanders

In some embodiments, the palatal expanders described herein are fabricated primarily or entirely from a thermoplastic polymer powder by additive manufacturing. For example, powder bed fusion techniques such as selective laser sintering (SLS) can be used to fabricate the palatal expander through sintering, melting, or otherwise fusing the thermoplastic polymer powder into a solid shape at selected locations, without forming new covalent bonds in the thermoplastic polymer powder, as described further in Section I.B below. The composition and properties of the thermoplastic polymer powder can be selected to (1) confer desired properties to the fabricated object (e.g., modulus, elongation, strength, stress relaxation, water uptake, compatibility), (2) provide good powder packing (e.g., to reduce or minimize empty space) and accurate fabrication (e.g., well-controlled, substantially uniform melting), and/or (3) be suitable for reuse in multiple fabrication processes with substantially no degradation.

In some embodiments, an additively manufactured object (e.g., a palatal expander) is produced using a thermoplastic polymer powder composed of a plurality of particles of a thermoplastic polymer. For example, the thermoplastic polymer can be selected from one or more of the following: a polyamide (e.g., polyamide 12, polyamide 11, polyamide 6, polyamide blend), polyoxymethylene (POM), polyaryletherketone (PAEK), polyether ether ketone (PEEK), polyetherketoneketone (PEKK), polybutylene terephthalate (PBT), polypropylene (PP), polycarbonate (PC), polysulfone, polyethylene (PE), or polymethyl methacrylate (PMMA). The thermoplastic polymer can have a molecular weight (number average or weight average) of at least 50 kDa, 75 kDa, 100 kDa, 150 kDa, 200 kDa, 250 kDa, 300 kDa, 350 kDa, 400 kDa, 450 kDa, 500 kDa, 550 kDa, 600 kDa, 650 kDa, 700 kDa, 750 kDa, 800 kDa, 850 kDa, 900 kDa, 950 kDa, or 1 MDa; and/or within a range from 100 kDa to 1 MDa, 100 kDa to 750 kDa, 100 kDa to 500 kDa, 100 kDa, 100 kDa to 200 kDa, 200 kDa to 1 MDa, 200 kDa to 750 kDa, 200 kDa to 500 kDa, 500 kDa to 1 MDa, 500 kDa to 750 kDa, or 750 kDa to 1000 MDa. In some embodiments, polymers with a higher molecular weight produce palatal expanders with improved mechanical properties (e.g., higher modulus and/or strength).

The particles of the thermoplastic polymer powder can have a sufficiently small size (e.g., diameter) to ensure good accuracy in sintering and/or melting during the additive manufacturing process, since excessively large particles may not melt completely and thus result in suboptimal material uniformity. For example, the particles can have a D90 value (90% of the particles are smaller than this size) that is less than or equal to 200 μm, 190 μm, 180 μm, 170 μm, 160 μm, 150 μm, 140 μm, 130 μm, 120 μm, 110 μm, 100 μm, 90 μm, 80 μm, 70 μm, 60 μm, or 50 μm; and/or within a range from 50 μm to 200 μm, 50 μm to 150 μm, 50 μm to 100 μm, 50 μm to 70 μm, 70 μm to 200 μm, 70 μm to 150 μm, 70 μm to 100 μm, 100 μm to 200 μm, 100 μm to 150 μm, or 150 μm to 200 μm. Alternatively or in combination, the particles can have a D50 value (50% of the particles are smaller than this size) that is less than or equal to 100 μm, 90 μm, 80 μm, 70 μm, 60 μm, 50 μm, 40 μm, 30 μm, or 20 μm; and/or within a range from 20 μm to 100 μm, 20μ m to 70 μm, 20 μm to 50 μm, 45 μm to 70 μm, 50 μm to 100 μm, 50μ m to 70 μm, or 70μ m to 100 μm. Alternatively or in combination, the particles can have a D10 value (10% of the particles are smaller than this size) that is less than or equal to 50 μm, 45 μm, 40 μm, 35 μm, 30 μm, 25 μm, 20 μm, 15 μm, or 10 μm; and/or within a range from 10 μm to 50 μm, 10 μm to 25 μm, 20 μm to 45 μm, or 25 μm to 50 μm.

The particles of the thermoplastic polymer powder can have a particle size distribution configured to provide consistent powder packing when deposited, which may reduce the amount of empty space within the bulk material of the additively manufactured object and thus improve the mechanical properties of the object. The uniformity of the particle size distribution may be quantified according to the span of the particle size distribution, which may be calculated according to the formula (D90−D10)/D50. In some embodiments, the span of the thermoplastic polymer powder is less than or equal to 1, 0.9, 0.8, 0.7, 0.6, or 0.5; and/or within a range from 0.5 to 1.

Table 1 lists representative examples of particle size distributions of a thermoplastic polymer powder that may be used to fabricate palatal expanders.

TABLE 1
Thermoplastic Polymer Powder Properties

| Lot # | D10 (μm) | D50 (μm) | D90 (μm) | Span |
|---|---|---|---|---|
| 1 | 38.4 | 59.2 | 90.0 | 0.9 |
| 2 | 36.9 | 58.0 | 89.4 | 0.9 |
| 3 | 37.1 | 58.2 | 90.0 | 0.9 |

In some embodiments, the thermoplastic polymer powder has a bulk density of at least 100 g/L, 150 g/L, 200 g/L, 250 g/L, 300 g/L, 350 g/L, 400 g/L, 450 g/L, 500 g/L, 550 g/L, 600 g/L, 650 g/L, 700 g/L, 750 g/L, 800 g/L, 850 g/L, 900 g/L, 950 g/L, or 1000 g/L; and/or within a range from 100 g/L to 1000 g/L, 200 g/L to 800 g/L, or 300 g/L to 750 g/L. In some embodiments, the thermoplastic polymer powder has a pourability of at least 5 seconds, 10 seconds, 15 seconds, 20 seconds, 25 seconds, 30 seconds, 35 seconds, 40 seconds, 45 seconds, 50 seconds, 55 seconds, or 60 seconds; and/or within a range from 5 seconds to 60 seconds, 15 seconds to 40 seconds, or 20 seconds to 30 seconds. Pourability may be quantified based on the amount of time for a defined mass of thermoplastic polymer powder to flow through a funnel of specified dimensions, e.g., according to ISO 6186. The density and pourability of the thermoplastic polymer powder may affect the printability of the powder and/or the final properties of the printed palatal expander.

The thermal properties of the thermoplastic polymer powder, such as melting temperature (Tm), crystallization temperature (Tc), glass transition temperature (Tg), and/or degradation temperature, can be selected for compatibility with the additive manufacturing process used. For instance, for SLS, the portions of the thermoplastic polymer powder used to form the object may be heated to a temperature between the Tm and the Tc. Temperatures too close to the Tc may produce defects (e.g., curling), while temperatures too close to the Tm may reduce the geometric accuracy of the object. The Tc may also affect the cooling profile of the thermoplastic polymer powder and the printed palatal expander. Moreover, since the thermoplastic polymer is in a rubbery state at temperature above the Tg, it may be desirable to remove the printed palatal expander from the surrounding powder cake only once the palatal expander and powder cake have cooled below the Tg and the palatal expander has reached its rigid state. The selection of the Tg can also compensate for shrinkage and/or thermal stress effects. Furthermore, it may be desirable to maintain the overall temperature of the thermoplastic polymer powder below the degradation temperature to ensure reusability of the unsintered powder. The Tm, Tc, and Tg of the thermoplastic polymer powder may be measured using differential scanning calorimetry (DSC), while the degradation temperature of the thermoplastic polymer powder may be measured using thermogravimetric analysis (TGA).

In some embodiments, the Tm of the thermoplastic polymer powder is at least 100° C., 120° C., 140° C., 160° C., 180° C., 200° C., 220° C., 240° C., or 250° C.; and/or is within a range from 100° C. to 250° C., 100° C. to 220° C., 100° C. to 200° C., 100° C. to 150° C., 150° C. to 250° C., 150° C. to 200° C., or 200° C. to 250° C.

In some embodiments, the Tc of the thermoplastic polymer powder is at least 100° C., 120° C., 140° C., 160° C., 180° C., 200° C., 220° C., 240° C., or 250° C.; and/or is within a range from 100° C. to 250° C., 100° C. to 220° C., 100° C. to 200° C., 100° C. to 150° C., 150° C. to 250° C., 150° C. to 200° C., or 200° C. to 250° C.

In some embodiments, the Tg of the thermoplastic polymer powder is at least 20° C., 30° C., 40° C., 50° C., 60° C., 80° C., 100° C., 120° C., 140° C., 160° C., 170° C., 180° C., or 200° C.; and/or is within a range from 20° C. to 200° C., 30° C. to 170° C., 50° C. to 150° C., or 100° C. to 200° C.

In some embodiments, the degradation temperature of the thermoplastic polymer powder is at least 200° C., 225° C., 250° C., 275° C., 300° C., 325° C., 350° C., 375° C., 400° C., 425° C., 450° C., 475° C., or 500° C.; and/or is within a range from 200° C. to 500° C., 270° C. to 500° C., 300° C. to 400° C., or 400° C. to 500° C.

The thermoplastic polymer powder may have a melt volume rate (MVR) (also known as a melt volume-flow rate) that is sufficiently high to achieve uniform and accurate melting during the fabrication process, which may affect the material consistency of the printed part. For example, the MVR can be at least 10 cm³/10 min, 20 cm³/10 min, 30 cm³/10 min, 40 cm³/10 min, 50 cm³/10 min, 60 cm³/10 min, 70 cm³/10 min, 80 cm³/10 min, 90 cm³/10 min, or 100 cm³/10 min; and/or within a range from 10 cm³/10 min to 100 cm³/10 min, 10 cm³/10 min to 50 cm³/10 min, 20 cm³/10 min to 90 cm³/10 min, 30 cm³/10 min to 80 cm³/10 min, 40 cm³/10 min to 70 cm³/10 min, or 50 cm³/10 min to 100 cm³/10 min. The MVR can be measured based on the volume of material that flows through a standard test setup within 10 minutes, e.g., according to ISO 1133.

In some embodiments, the thermoplastic polymer powder has one or more of the properties listed in Table 2 below.

TABLE 2
Thermoplastic Polymer Powder Properties

| Property | Range |
|---|---|
| D10 - Particle size at cumulative percentage of 10% | 20-45 |
| (μm) (10% of particles in the powder are smaller than | |
| this size, ISO 13320) | |
| D50 - Particle size at cumulative percentage of 50% | 45-70 |
| (μm) (50% of particles in the powder are smaller than | |
| this size, ISO 13320) | |
| D90 - Particle size at cumulative percentage of 90% | 70-150 |
| (μm) (90% of particles in the powder are smaller than | |
| this size, ISO 13320) | |
| Span of particle size distribution | 0.5-1 |
| ((D90-D10)/D50, ISO 13320) | |
| Bulk density (g/L) - ISO 60 | 300-750 |
| Pourability (s) - ISO 6186 | 15-40 |
| DSC melting point temperature (° C.): 1st heat scan | 100-220 |
| DSC melting point temperature (° C.): 2nd heat scan | 100-220 |
| DSC crystallization temperature (° C.) | 100-200 |
| DSC glass transition temperature (° C.) | 30-170 |
| TGA degradation temperature (° C.) | 270-500 |
| Melt volume rate (cm³/10 min) | 30-80 |
| Number average molecular weight (kDalton) | 100-500 |
| Weight average molecular weight (kDalton) | 100-750 |

In some embodiments, the thermoplastic polymer powder includes at least one additive to improve and/or modify the overall properties of the powder. For example, flow agents can be added into the powder to improve flowability and/or inhibit caking, and thus provide a more uniform, consistent layer of powder on the build platform. Examples of flow agents that may be used include silica-based materials (e.g., silicon dioxide, hydrophobic fumed silica), calcium-based materials (e.g., calcium silicate, calcium stearate, tricalcium phosphate), and magnesium stearate. The flow agent can be a biocompatible (e.g., food-safe) compound. In some embodiments, the flow agent constitutes up to 0.5 wt %, 1 wt %, 1.5 wt %, 2 wt %, 2.5 wt %, 3 wt %, 3.5 wt %, 4 wt %, 4.5 wt %, or 5 wt % of the thermoplastic polymer powder; and/or the flow agent can constitute from 0.5 wt % to 5 wt %, 0.5 wt % to 4 wt %, 0.5 wt % to 3 wt %, 0.5 wt % to 2 wt %, 0.5 wt % to 1 wt %, 1 wt % to 5 wt %, 1 wt % to 4 wt %, 1 wt % to 3 wt %, 1 wt % to 2 wt %, 2 wt % to 5 wt %, 2 wt % to 4 wt %, 2 wt % to 3 wt %, 3 wt % to 5 wt %, 3 wt % to 4 wt %, or 4 wt % to 5 wt % of the thermoplastic polymer powder.

### B. Methods for Additive Manufacturing of Palatal Expanders

As discussed above, the palatal expanders described herein may be fabricated via additive manufacturing. Additive manufacturing (also referred to herein as “3D printing”) includes a variety of technologies which fabricate 3D objects directly from digital models through an additive process. In some embodiments, additive manufacturing includes depositing a precursor material (e.g., a thermoplastic polymer powder as described in Section I.A above) onto a build platform. The precursor material can be sintered, fused, melted, cured, polymerized, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps.

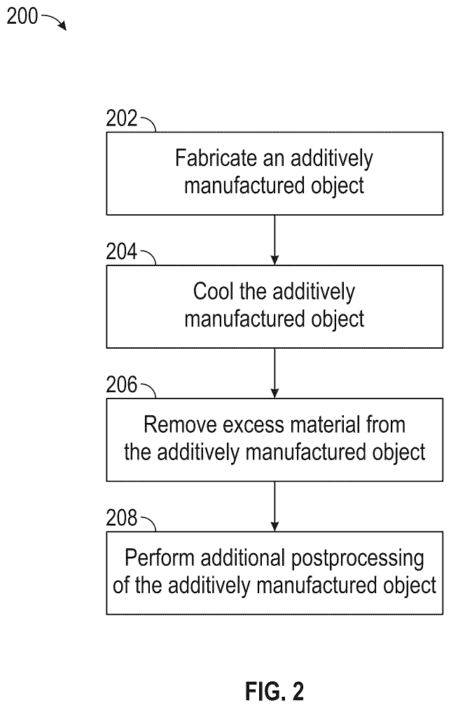

FIG. 2 is a flow diagram providing a general overview of a method 200 for fabricating and processing an additively manufactured object, in accordance with embodiments of the present technology. The method 200 can be used to fabricate many different types of additively manufactured objects, such as the palatal expanders described herein.

The method 200 begins at block 202 with fabricating an additively manufactured object (e.g., a palatal expander). The object may be fabricated partially or entirely from a powder, such as a thermoplastic polymer powder as described in Section I.A above, using a powder bed fusion process (e.g., selective heat sintering (SHS) or selective laser sintering (SLS)). The composition and properties of the powder can be selected to confer desired properties to the fabricated object, provide good packing and high geometry accuracy during additive manufacturing, and/or be suitable for reuse in multiple additive manufacturing processes with substantially no degradation.

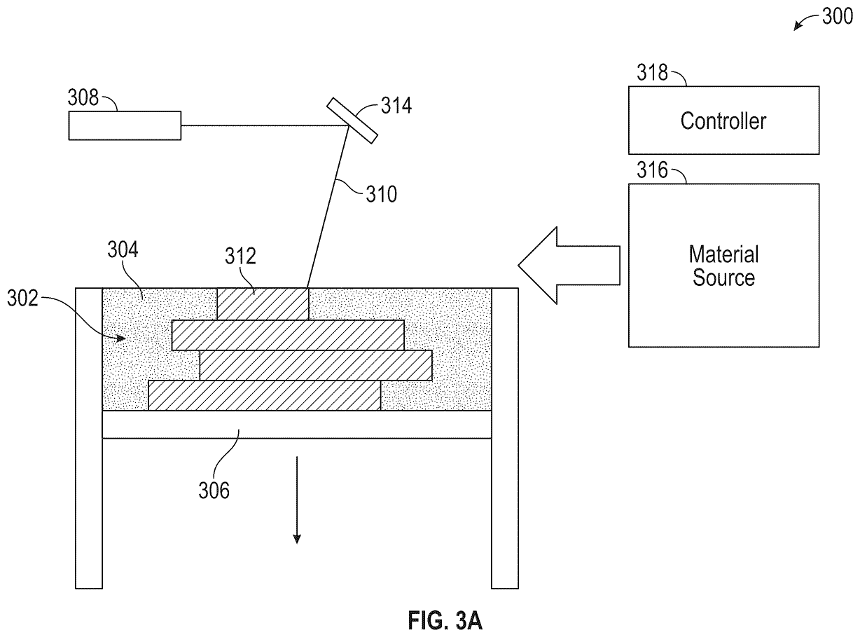

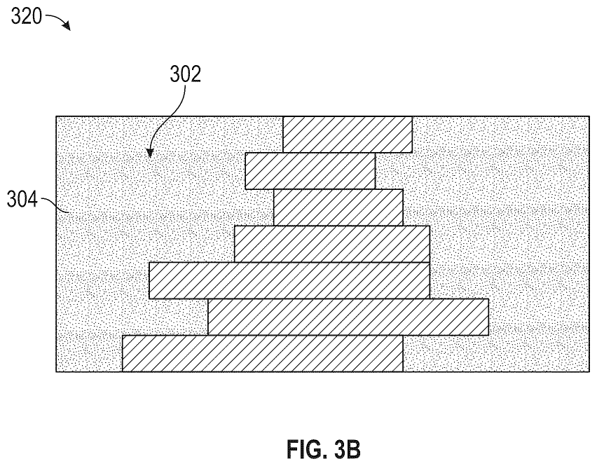

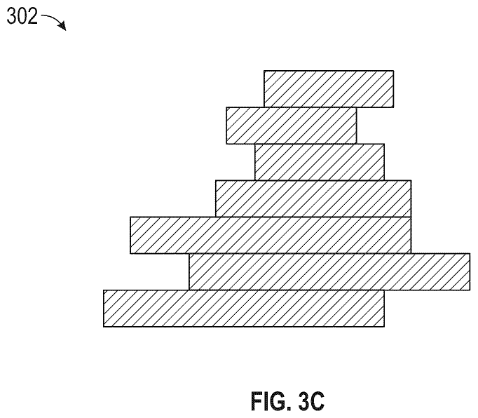

For example, FIG. 3A is a partially schematic diagram of an additive manufacturing system 300 configured in accordance with embodiments of the present technology. The system 300 is configured to fabricate an additively manufactured object 302 (“object 302”) using a powder bed fusion process, such as SLS. As shown in FIG. 3A, the system 300 includes a bed of powder 304 (e.g., a thermoplastic polymer powder as described in Section I.A) on a build platform 306. The powder 304 may include fresh (unused) powder, reused powder recycled from previous fabrication processes, or a combination thereof (e.g., a mixture of fresh and reused powder). In some embodiments, the powder 304 is spread in a thin, uniform layer on the build platform 306. The powder 304 may be heated to a temperature near the melting temperature of the thermoplastic polymer powder. The powder 304 may be maintained in an inert atmosphere (e.g., nitrogen) to prevent thermo-oxidation during the fabrication process.

The system 300 also includes an energy source 308 (e.g., a laser source or electron beam source) that outputs energy 310 (e.g., a laser or electron beam) at an intensity configured to sinter, melt, or otherwise fuse the powder 304 into a cohesive object layer 312 on the build platform 306 and/or a previously formed portion of the object 302. A scanner 314 (e.g., a mirror and/or other optical elements) can be used to direct the energy 310 into a suitable pattern on the powder 304 to form the object layer 312. The geometry of the object layer 312 can correspond to the desired geometry for a corresponding cross-section of the object 302. The energy 310 can be selectively applied to the powder 304 such that portions of the powder 304 that are not intended to become part of the object layer 302 remain substantially unaffected (e.g., unfused).

Once the object layer 312 has been formed, the build platform 306 can be lowered by a predetermined amount. A material source 316 (shown schematically) can then apply a fresh layer of powder 304 onto the formed object layer 312 and previously deposited powder 304. For example, the material source 316 can include a reservoir of powder 304 (e.g., hopper, feed cartridge with movable piston) and/or a smoothing device (e.g., doctor blades, recoater blades, rollers) that applies and smooths the deposited powder 304 into a thin, uniform layer. The energy 310 can then be applied to the fresh layer of powder 304 to form the next object layer 312. The fabrication process can be repeated to iteratively build up individual object layers 312 on the build platform 306 until the object 302 is complete. The object 302 can then be removed from the system 300 for post-processing, as described further below.

In some embodiments, the system 300 also includes a controller 318 that is operably coupled to the build platform 306, energy source 308, and material source 316 to control the operation thereof. The controller 318 can be or include a computing device including one or more processors and memory storing instructions for performing the additive manufacturing operations described herein. For example, the controller 318 can receive a digital data set (e.g., a 3D model or a plurality of 2D slices) representing the object 302 to be fabricated, determine a plurality of object cross-sections to build up the object 302 from the powder 304, and can transmit instructions to the energy source 308 to output energy 310 to form a plurality of object layers 312 corresponding to the object cross-sections. Additionally, the controller 318 can also determine and control other operational parameters, such as the positioning of the build platform 306 (e.g., height) and/or the amount of powder 304 deposited by the material source 316.

Referring again to FIG. 2, after the additively manufactured object is fabricated, the object can undergo one or more additional process steps, also referred to herein as “post-processing.” For example, at block 204, the additively manufactured object can be cooled after fabrication. The energy involved in certain types of additive manufacturing processes can result in heating of the object and/or surrounding precursor material to an elevated temperature. For instance, the energy used in a powder bed fusion process such as SLS can heat the object and/or surrounding powder to a temperature of 100° C., 125° C., 150° C., 160° C., 170° C., 180° C., 190° C., 200° C., or more. Accordingly, the object and/or surrounding material may need to be cooled to a lower temperature before subsequent processing, such as a temperature less than or equal to 100° C., 90° C., 80° C., 70° C., 60° C., 50° C., 30° C., or 25° C. The cooling process can take at least 1 hour, 2 hours, 4 hours, 8 hours, 10 hours, 12 hours, or 24 hours. In some embodiments, to reduce downtime of the additive manufacturing system, the object is removed from the additive manufacturing system and transported to a separate cooling system. The cooling system can also include environmental control mechanisms (e.g., an inert atmosphere such as nitrogen) to avoid exposing the object to excessive temperature fluctuations and/or oxidizing conditions. Representative examples of systems and methods for cooling additively manufactured objects are provided in U.S. Patent Publication No. 2025/0018650, the disclosure of which is incorporated by reference herein in its entirety.

At block 206, the method 200 can continue with removing excess material from the additively manufactured object. The excess material can include unincorporated precursor material (e.g., unsintered powder) and/or other unwanted material (e.g., debris) that remains on and/or within the object after the additive manufacturing process. The excess material can be removed in many different ways, such as by applying mechanical forces to the object (e.g., vibration, centrifugation, tumbling, brushing), exposing the object to a solvent (e.g., via spraying, immersion), heating or cooling the object, applying a vacuum to the object, blowing a pressurized gas onto the object, and/or other suitable techniques. Optionally, the excess material can be collected and/or processed for reuse. Representative examples of systems and methods for removing excess material from additively manufactured objects are provided in U.S. Patent Publication No. 2025/0018650, the disclosure of which is incorporated by reference herein in its entirety.

For example, referring to FIG. 3B, the output of a powder bed fusion process can be a powder cake 320 containing the object 302 embedded within the unsintered powder 304. Depending on the size of the object 302, the powder 304 can constitute a relatively large volume of the powder cake 320, such as at least 50%, 60%, 70%, 80%, or 90% of the total volume of the powder cake 320. Post-processing of the object 302 can include extracting the object 302 from the powder cake 320 (“decaking”) and removing residual powder 304 adhered to the surfaces of the object 302 (“depowdering”) to produce a cleaned object 302 (FIG. 2C). Optionally, some or all of the removed powder 304 can be collected and/or processed for reuse, as discussed further below.

Referring again to FIG. 2, at block 206, the method 200 can optionally include performing additional post-processing of the object. For example, the additional post-processing can include modifying at least one surface of the object. The surface modifications can be applied to some or all of the surfaces of the object (e.g., the exterior and/or interior surfaces) to alter one or more surface characteristics, such as the surface finish (e.g., roughness, waviness, lay), porosity, visual appearance (e.g., gloss, transparency, visibility of print lines), hydrophobicity, and/or chemical reactivity. In some embodiments, the surface modifications include removing material from the object, e.g., by polishing, abrading, blasting, etc. Alternatively or in combination, the surface modifications can include applying an additional material to the object. For example, the additional material can be a coating, such as a polymeric coating. The coating can be applied to one or more surfaces of the object for various purposes, including, but not limited to: providing a smooth surface finish, which can be beneficial for aesthetics and/or to improve user comfort if the object is intended to be in contact with the user's body (e.g., a dental appliance worn on the teeth); coloring and/or applying other aesthetic features to the object; improving scratch resistance and/or other mechanical properties; providing antimicrobial properties; and incorporating therapeutic agents into the object for controlled release. Representative examples of systems and methods for modifying the surfaces of additively manufactured objects are provided in U.S. Patent Publication No. 2024/0091906, the disclosure of which is incorporated by reference herein in its entirety.

Other examples of additional post-processing that may be performed include, but are not limited to, additional cleaning of the object (e.g., washing with water, solvents, etc.); post-curing and/or annealing the additively manufactured object; trimming or otherwise separating the object from any substrates, supports, and/or other structures that are not intended to be present in the final product; and packaging the object for shipment.

The method 200 illustrated in FIG. 2 can be modified in many different ways. For example, although the above processes of the method 200 are described with respect to a single object, the method 200 can be used to sequentially or concurrently fabricate and post-process any suitable number of objects, such as tens, hundreds, or thousands of additively manufactured objects. As another example, the ordering of the processes shown in FIG. 2 can be varied. Some of the processes of the method 200 can be omitted, such as the processes of any of blocks 204, 206, or 208. The method 200 can also include additional processes not shown in FIG. 2.

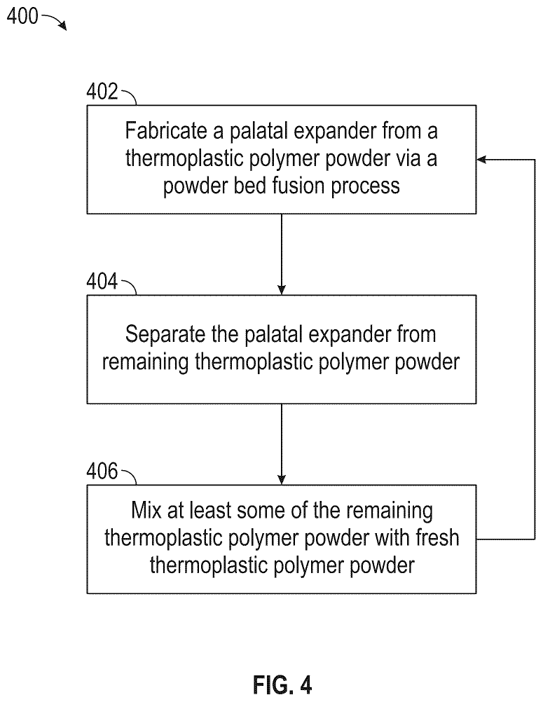

FIG. 4 is a flow diagram illustrating a method 400 for fabricating an additively manufactured palatal expander, in accordance with embodiments of the present technology. The method 400 can be combined with any of the other methods described herein, such as the method 200 of FIG. 2.

The method 400 can begin at block 402 with fabricating a palatal expander from a thermoplastic polymer powder via a powder bed fusion process. The process of block 402 can be identical or generally similar to the process of block 202 of the method 200 of FIG. 2. For example, the powder bed fusion process can involve depositing a layer of the thermoplastic polymer powder, and then applying energy to the layer of the thermoplastic polymer powder to form a layer of the palatal expander. This process can be repeated to build up the geometry of the palatal expander in a layer-by-layer manner.

The thermoplastic polymer powder can have any of the features described in Section I.A above. For example, the thermoplastic polymer powder can be composed of a polyamide, polyoxymethylene (POM), polyaryletherketone (PAEK), polyether ether ketone (PEEK), polyetherketoneketone (PEKK), polybutylene terephthalate (PBT), polypropylene (PP), polycarbonate (PC), polysulfone, polyethylene (PE), and/or polymethyl methacrylate (PMMA). The thermoplastic polymer powder can have a particle size configured to provide good geometric accuracy in melting and/or sintering during the powder bed fusion process, e.g., the thermoplastic polymer powder can have a D90 value within a range from 70 μm to 150 μm, a D10 value within a range from 20 μm to 45 μm, a D50 value within a range from 45 μm to 70 μm, and/or a particle size span within a range from 0.5 to 1.

The thermal properties of the thermoplastic polymer powder can also be selected for accurate melting and/or sintering, e.g., the thermoplastic polymer powder can have a melt volume rate within a range from 30 cm³/10 min to 150 cm³/10 min, a melting temperature within a range from 100° C. to 220° C., a crystallization temperature within a range from 100° C. to 200° C., a glass transition temperature within a range from 30° C. to 170° C., or a degradation temperature within a range from 270° C. to 500° C. During the powder bed fusion process, the thermoplastic polymer powder may be heated to a temperature above the crystallization temperature (e.g., to prevent curling) and at or below the melting temperature to form a layer of the palatal expander. The entire powder bed may be maintained below the degradation temperature during the powder bed fusion process to ensure that there is substantially no degradation of unused powder. Optionally, the thermoplastic polymer powder may include at least one additive to improve the properties of the powder, such as a flow agent to improve flowability and/or prevent caking.

At block 404, the method 400 can include separating the palatal expander from remaining thermoplastic polymer powder (e.g., unused thermoplastic polymer powder that was not sintered and/or melted during the powder bed fusion process to become part of the palatal expander). The process of block 404 may be identical or generally similar to the process of block 206 of the method 200 of FIG. 2. For instance, the remaining thermoplastic polymer powder can be separated from the fabricated palatal expander via mechanical forces, such as vibration, centrifugation, tumbling, brushing, etc. Optionally, the palatal expander and remaining thermoplastic polymer powder may undergo a cooling process before the separation, e.g., as previously described with respect to block 204 of the method 200 of FIG. 2.

At block 406, the method 400 can optionally include mixing at least some of the remaining thermoplastic polymer powder with fresh thermoplastic polymer powder (e.g., thermoplastic polymer powder that has not been previously used in a powder bed fusion process). The remaining thermoplastic polymer powder can be sieved, filtered, or otherwise processed to remove debris before mixing. The remaining and fresh thermoplastic polymer powder may be combined in any suitable weight ratio, such as 10:90, 20:80, 30:70, 40:60, 50:50, 60:40, 70:30, 80:20, or 10:90. In some embodiments, the remaining thermoplastic polymer powder constitutes at least 10 wt %, 20 wt %, 30 wt %, 40 wt %, 50 wt %, 60 wt %, 70 wt %, 80 wt %, or 90 wt %; and/or up to 10 wt %, 20 wt %, 30 wt %, 40 wt %, 50 wt %, 60 wt %, 70 wt %, 80 wt %, or 90 wt % of the mixture. Mixing can be performed using any suitable device, such as a powder mixer that uses rotating blades, rotating and/or vibrating drums, etc., to combine the remaining and fresh thermoplastic powder into a uniform mixture.

The mixture can then be reused in a subsequent powder bed fusion process to fabricate additional palatal expanders. In some embodiments, the thermoplastic polymer powder may be reused in at least two, three, four, five, 10, 20, or 50 subsequent powder bed fusion processes. As noted above, because the thermoplastic polymer powder is maintained below the degradation temperature and/or in an inert environment during fabrication and post-processing, it is expected to undergo substantially no degradation, and thus may be reused without significant changes in properties from batch to batch. Moreover, because the reused thermoplastic polymer powder is combined with fresh thermoplastic polymer powder for each powder bed fusion process, the amount of reused powder is gradually diluted (e.g., if a 50:50 weight ratio of reused and fresh powder is used for each iteration, after 10 iterations, the oldest powder from the first iteration will constitute only 0.024 wt % of the total powder used), thus further ensuring fabrication consistency and quality.

The method 400 illustrated in FIG. 4 can be modified in many different ways. For example, although the above processes of the method 400 are described with respect to a single palatal expander, the method 400 can be used to sequentially or concurrently fabricate and post-process any suitable number of palatal expanders, such as tens, hundreds, or thousands of palatal expanders. As another example, the ordering of the processes shown in FIG. 4 can be varied. Some of the processes of the method 400 can be omitted, such as the process of block 406, such that recycling of the thermoplastic polymer powder is optional. The method 400 can also include additional processes not shown in FIG. 4.

The materials and methods described herein can yield palatal expanders with properties well suited for palatal expansion treatment, e.g., the palatal expander has sufficient stiffness and strength to exert forces needed to expand the palatal suture, sufficient durability to maintain such forces in the warm and humid oral environment over extended time periods, and biocompatibility suitable for oral use.

In some embodiments, the palatal expander has a tensile modulus of at least 500 MPa, 600 MPa, 700 MPa, 800 MPa, 900 MPa, 1000 MPa, 1500 MPa, 2000 MPa, 2500 MPa, 3000 MPa, 3500 MPa, 4000 MPa, 4500 MPa, or 5000 MPa; and/or within a range from 500 MPa to 5000 MPa, 500 MPa to 3000 MPa, 5000 MPa to 1000 MPa, 900 MPa to 3000 MPa, 1000 MPa to 5000 MPa, 1000 MPa to 3000 MPa, 1000 MPa to 2000 MPa, or 2000 MPa to 5000 MPa. In some embodiments, the palatal expander has a tensile strength at yield of at least 10 MPa, 20 MPa, 30 MPa, 40 MPa, or 50 MPa. In some embodiments, the palatal expander has an offset yield strength at 0.2% strain of at least 10 MPa, 20 MPa, 30 MPa, 40 MPa, or 50 MPa. In some embodiments, the palatal expander has an elongation at break of at least 1%, 2%, 5%, 8%, or 10%. The tensile modulus, tensile strength at yield, elongation at break, and offset yield strength may be measured, for example, at room temperature (e.g., 20-25° C.) using a standard coupon of the palatal expander material (e.g., an ASTM D638 IV dog bone coupon with 3 mm thickness).

In some embodiments, the palatal expander has a dry flexural modulus of at least 500 MPa, 600 MPa, 700 MPa, 800 MPa, 900 MPa, 1000 MPa, 1500 MPa, 2000 MPa, 2500 MPa, 3000 MPa, 3500 MPa, 4000 MPa, 4500 MPa, or 5000 MPa; and/or within a range from 500 MPa to 5000 MPa, 500 MPa to 2000 MPa, 5000 MPa to 1000 MPa, 1000 MPa to 5000 MPa, 1000 MPa to 3000 MPa, 1000 MPa to 2000 MPa, or 2000 MPa to 5000 MPa. The dry flexural modulus may be measured, for example, at room temperature (e.g., 20-25° C.) using a standard coupon of the palatal expander material (e.g., an ASTM D790 coupon that is 50 mm in length×10.5 mm in width×0.8 mm in thickness).

In some embodiments, the palatal expander has a wet flexural modulus of at least 20 MPa, 30 MPa, 40 MPa, 50 MPa, 60 MPa, 70 MPa, 80 MPa, 90 MPa, 100 MPa, 200 MPa, 300 MPa, 400 MPa, or 500 MPa; and/or within a range from 20 MPa to 500 MPa, 50 MPa to 500 MPa, 50 MPa to 300 MPa, 50 MPa to 100 MPa, 100 MPa to 500 MPa, 100 MPa to 300 MPa, or 200 MPa to 500 MPa. In some embodiments, the palatal expander has a stress relaxation in a wet environment of no more than 5%, 10%, 15%, 20%, 25%, 30%, 40%, or 50%. In some embodiments, the palatal expander has a water uptake in a wet environment of no more than 1%, 2%, 5%, 8%, 10%, 15%, or 20%; and/or within a range from 0% to 20%, 0% to 10%, 0% to 8%, or 0% to 5%. The wet flexural modulus, stress relaxation in a wet environment, and water uptake in a wet environment may be measured, for example, by testing a standard coupon of the palatal expander material (e.g., a coupon that is 50 mm in length×21 mm in width×0.8 mm in thickness) after 24 hours of immersion in water at physiological temperature (e.g., 37° C.).

In some embodiments, the palatal expander has a Tg of at least 20° C., 25° C., 30° C., 35° C., 40° C., 45° C., or 50° C.; and/or within a range from 30° C. to 50° C. The Tg can be measured, for example, via a dynamic mechanical analysis (DMA) temperature sweep of a standard coupon of the palatal expander material (e.g., a coupon that is 50 mm in length×5 mm in width×0.8 mm in thickness) based on the peak of the loss modulus of the coupon.

In some embodiments, the palatal expander has a storage modulus of at least 1000 MPa, 1400 MPa, 1500 MPa, 2000 MPa, 2500 MPa, 3000 MPa, 3500 MPa, 4000 MPa, 4500 MPa, or 5000 MPa; and/or within a range from 1000 MPa to 5000 MPa, 1400 MPa to 3000 MPa, 1000 MPa to 2000 MPa, 2000 MPa to 5000 MPa, 2000 MPa to 3000 MPa, 3000 MPa to 5000 MPa, or 4000 MPa to 5000 MPa. The storage modulus may be measured, for example, via DMA of a standard coupon of the palatal expander material (e.g., a coupon that is 50 mm in length×5 mm in width×0.8 mm in thickness) at room temperature (e.g., 20-25° C.).

The palatal expander may be biocompatible, e.g., causing substantially no cytotoxicity, sensitization, irritation, systemic toxicity, pyrogenicity, and/or genotoxicity when worn.

In some embodiments, an additively manufactured palatal expander fabricated from a thermoplastic polymer powder as described herein has one or more of the properties listed in Table 3 below.

TABLE 3
Palatal Expander Properties

| Property | Range |
|---|---|
| Tensile modulus at room temperature (MPa) - ASTM | 900-3000 |
| D638 IV dog bone with 3 mm thickness | |
| Tensile strength at yield at room temperature (MPa) - | >20 |
| ASTM D638 IV dog bone with 3 mm thickness | |
| Elongation at break at room temperature (%) - ASTM | >5 |
| D638 IV dog bone with 3 mm thickness | |
| Offset yield strength at 0.2% strain at room | >20 |
| temperature (MPa) - ASTM D638 IV dog bone with 3 | |
| mm thickness | |
| Flexural modulus, Dry, at 23° C. (MPa) - ASTM D790, | 500-2000 |
| sample dimensions: 50 mm length × 10.5 mm width × | |
| 0.8 mm thickness | |
| Flexural modulus after 24 hours in a wet environment | 50-300 |
| at 37° C. (MPa) - Instron stress relaxation test, sample | |
| dimensions: 50 mm length × 21 mm width × 0.8 mm | |
| thickness | |
| % stress relaxation after 24 hours in a wet | >20 |
| environment at 37° C. - Instron stress relaxation test, | |
| sample dimensions: 50 mm length × 21 mm width × | |
| 0.8 mm thickness | |
| % water uptake after 24 hours in a wet environment at | 0-8 |
| 37° C. - Instron stress relaxation test, sample | |
| dimensions: 50 mm length × 21 mm width × 0.8 mm | |
| thickness | |
| Biocompatibility | Biological safety meeting cytotoxicity, |
| | sensitization, intracutaneous and oral |
| | irritation, acute systemic toxicity, |
| | pyrogenicity, subacute/subchronic systemic |
| | toxicity, genotoxicity requirements |
| DMA glass transition temperature Tg (° C.) of printed | 30-50 |
| coupon - peak of loss modulus E″ - sample | |
| dimensions: 50 mm length × 5 mm width × 0.8 mm | |
| thickness | |
| DMA storage modulus (MPa) @ 23° C. of printed | 1400-3000 |
| coupon - sample dimensions: 50 mm length × 5 mm | |
| width × 0.8 mm thickness | |

### II. Dental Appliances and Associated Methods

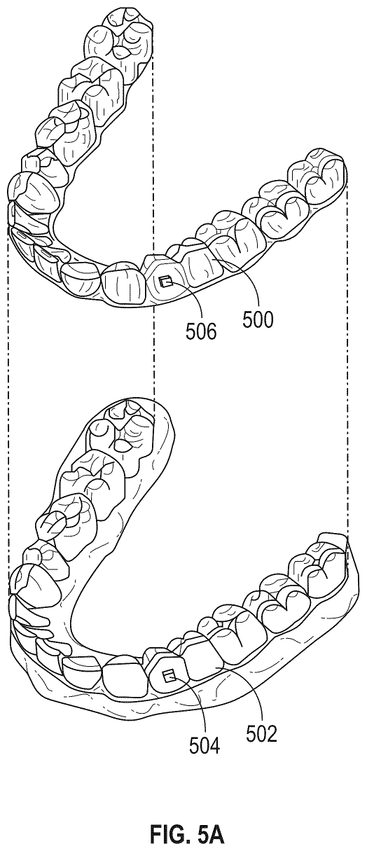

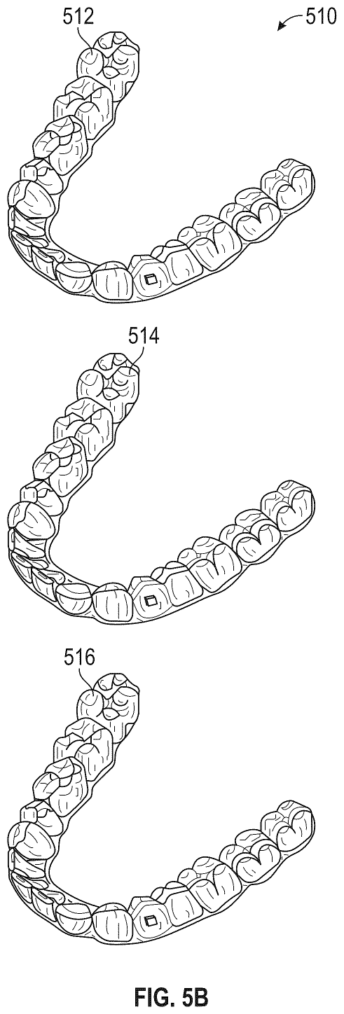

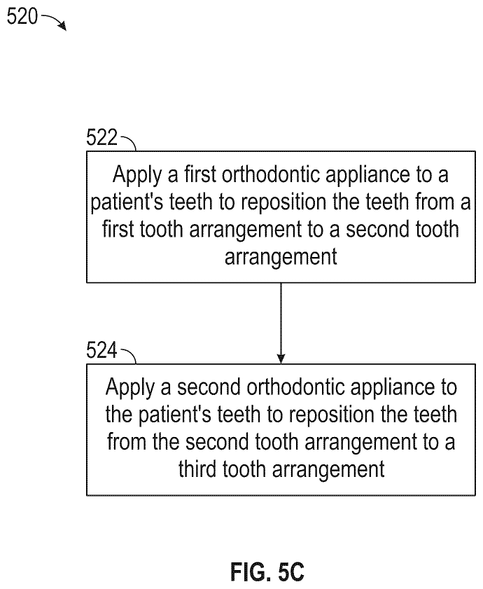

FIG. 5A illustrates a representative example of a tooth repositioning appliance 500 configured in accordance with embodiments of the present technology. The appliance 500 can be manufactured by or used with any of the systems, methods, and devices described herein. The appliance 500 (also referred to herein as an “aligner”) can be worn by a patient in order to achieve an incremental repositioning of individual teeth 502 in the jaw. The appliance 500 can include a shell (e.g., a continuous polymeric shell or a segmented shell) having teeth-receiving cavities that receive and resiliently reposition the teeth. The appliance 500 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 500 can fit over all teeth present in an upper or lower jaw, or less than all of the teeth. The appliance 500 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 500 can be a generic appliance configured to receive the teeth, but not necessarily shaped to match the topography of the patient's teeth. In some cases, only certain teeth received by the appliance 500 are repositioned by the appliance 500 while other teeth can provide a base or anchor region for holding the appliance 500 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 500 in place over the teeth. In some cases, however, it may be desirable or necessary to provide individual attachments 504 or other anchoring elements on teeth 502 with corresponding receptacles 506 or apertures in the appliance 500 so that the appliance 500 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 5B illustrates a tooth repositioning system 510 including a plurality of appliances 512, 514, 516, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 510 can include a first appliance 512 corresponding to an initial tooth arrangement, one or more intermediate appliances 514 corresponding to one or more intermediate arrangements, and a final appliance 516 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 5C illustrates a method 520 of orthodontic treatment using a plurality of appliances, in accordance with embodiments of the present technology. The method 520 can be practiced using any of the appliances or appliance sets described herein. In block 522, a first orthodontic appliance is applied to a patient's teeth in order to reposition the teeth from a first tooth arrangement to a second tooth arrangement. In block 524, a second orthodontic appliance is applied to the patient's teeth in order to reposition the teeth from the second tooth arrangement to a third tooth arrangement. The method 520 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

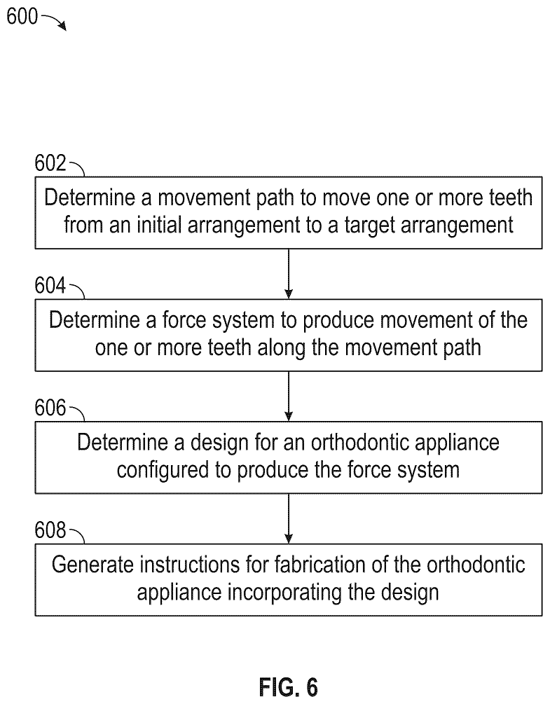

FIG. 6 illustrates a method 600 for designing an orthodontic appliance, in accordance with embodiments of the present technology. The method 600 can be applied to any embodiment of the orthodontic appliances described herein. Some or all of the steps of the method 600 can be performed by any suitable data processing system or device, e.g., one or more processors configured with suitable instructions.

In block 602, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 604, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 604 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 606, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 608, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 600 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 600 may be performed with any suitable fabrication system or device, such as the embodiments described herein. Some of the steps may be optional, e.g., the process of block 604 can be omitted, such that the orthodontic appliance is designed based on the desired tooth movements and/or determined tooth movement path, rather than based on a force system. Moreover, the order of the steps can be varied as desired.

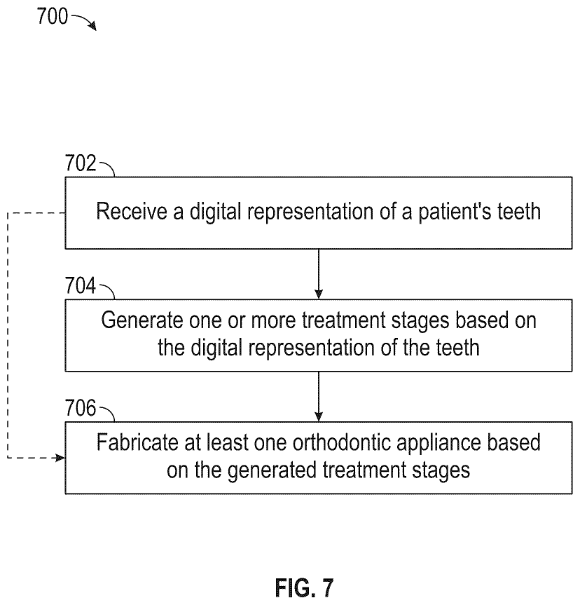

FIG. 7 illustrates a method 700 for digitally planning an orthodontic treatment and/or design or fabrication of an appliance, in accordance with embodiments. The method 700 can be applied to any of the treatment procedures described herein and can be performed by any suitable data processing system.

In block 702, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 704, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 706, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 7, design and/or fabrication of an orthodontic appliance, and perhaps a particular orthodontic treatment, may include use of a representation of the patient's teeth (e.g., including receiving a digital representation of the patient's teeth (block 702)), followed by design and/or fabrication of an orthodontic appliance based on a representation of the patient's teeth in the arrangement represented by the received representation.

As noted herein, the techniques described herein can be used with or for directly fabricated dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used with or for attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A method comprising:
fabricating an additively manufactured palatal expander from a thermoplastic polymer powder via a powder bed fusion process, wherein the thermoplastic polymer powder has a D90 value within a range from 70 μm to 150 μm, a D50 value within a range from 45 μm to 70 μm, a D10 value within a range from 20 μm to 45 μm, and a melt volume rate within a range from 30 cm³/10 min to 150 cm³/10 min;
separating the additively manufactured palatal expander from remaining thermoplastic polymer powder;
mixing at least some of the remaining thermoplastic polymer powder with fresh thermoplastic polymer powder; and
using the mixture in a subsequent powder bed fusion process.

Example 2. The method of Example 1, wherein the powder bed fusion process comprises a selective laser sintering (SLS) process.

Example 3. The method of Example 1 or 2, wherein the powder bed fusion process comprises:
depositing a layer of the thermoplastic polymer powder, and applying energy to the layer of the thermoplastic polymer powder to form a layer of the
additively manufactured palatal expander.

Example 4. The method of any one of Examples 1 to 3, wherein the mixture comprises at least 50 wt % of the remaining thermoplastic polymer powder.

Example 5. The method of any one of Examples 1 to 4, wherein the remaining thermoplastic powder is suitable for reuse in at least ten subsequent powder bed fusion processes.

Example 6. The method of any one of Examples 1 to 5, wherein the thermoplastic polymer powder comprises one or more of the following: a polyamide, polyoxymethylene (POM), polyaryletherketone (PAEK), polyether ether ketone (PEEK), polyetherketoneketone (PEKK), polybutylene terephthalate (PBT), polypropylene (PP), polycarbonate (PC), polysulfone, polyethylene (PE), or polymethyl methacrylate (PMMA).

Example 7. The method of any one of Examples 1 to 6, wherein the thermoplastic polymer powder is composed of a polymer having a number average molecular weight within a range from 100 kDa to 500 kDa.

Example 8. The method of any one of Examples 1 to 7, wherein the thermoplastic polymer powder has a particle size distribution having a span within a range from 0.5 to 1.

Example 9. The method of any one of Examples 1 to 8, wherein the thermoplastic polymer powder has one or more of the following: a melting temperature within a range from 100° C. to 220° C., a crystallization temperature within a range from 100° C. to 200° C., a glass transition temperature within a range from 30° C. to 170° C., or a degradation temperature within a range from 270° C. to 500° C.

Example 10. The method of Example 9, wherein the powder bed fusion process comprises selectively heating the thermoplastic polymer powder to a temperature below the melting temperature.

Example 11. The method of Example 9 or 10, wherein the powder bed fusion process comprises selectively heating the thermoplastic polymer powder to a temperature above the crystallization temperature.

Example 12. The method of any one of Examples 9 to 11, wherein the thermoplastic polymer powder is maintained below the degradation temperature during the powder bed fusion process.

Example 13. The method of any one of Examples 1 to 12, wherein the thermoplastic polymer powder comprises at least one flow agent.

Example 14. The method of Example 13, wherein the at least one flow agent comprises a silica-based material, a calcium-based material, magnesium stearate, or a combination thereof.

Example 15. The method of Example 13 or 14, wherein the at least one flow agent constitutes up to 5 wt % of the thermoplastic polymer powder.

Example 16. The method of any one of Examples 1 to 15, wherein the additively manufactured palatal expander has one or more of the following: a tensile modulus within a range from 900 MPa to 3000 MPa, a dry flexural modulus within a range from 500 MPa to 2000 MPa, a wet flexural modulus within a range from 50 MPa to 300 MPa, or a storage modulus within a range from 1400 MPa to 3000 MPa.

Example 17. The method of any one of Examples 1 to 16, wherein the additively manufactured palatal expander comprises:
a first tooth engagement portion configured to receive one or more first teeth at a first side of a dental arch of a patient,
a second tooth engagement portion configured to receive one or more second teeth at a second side of the dental arch, and
a palatal portion between the first and second tooth engagement portions, wherein the palatal portion is configured to apply forces to the first and second tooth engagement portions to expand a palate of the patient.

Example 18. The method of any one of Examples 1 to 17, wherein the additively manufactured palatal expander is one of a series of a palatal expanders configured to incrementally expand a palate of a patient.

Example 19. The method of any one of Examples 1 to 18, wherein the subsequent powder bed fusion process comprises fabricating an additional additively manufactured palatal expander from the mixture.

Example 20. An additively manufactured palatal expander fabricated according to the method of any one of Examples 1 to 19.

Example 21. A system for fabricating an additively manufactured palatal expander, the system comprising:
a build platform;
a material source configured to deposit a thermoplastic polymer powder onto the build platform, wherein the thermoplastic polymer powder has a D90 value within a range from 70 μm to 150 μm, a D50 value within a range from 45 μm to 70 μm, a D10 value within a range from 20 μm to 45 μm, and a melt volume rate within a range from 30 cm³/10 min to 150 cm³/10 min, and wherein the thermoplastic polymer powder comprises a mixture of a fresh thermoplastic polymer powder and reused thermoplastic polymer powder; and
an energy source configured to apply energy to the thermoplastic polymer powder according to a powder bed fusion process to form at least a portion of the additively manufactured palatal expander.

Example 22. The system of Example 21, wherein the powder bed fusion process comprises a selective laser sintering (SLS) process.

Example 23. The system of Example 21 or 22, wherein the mixture comprises at least 50 wt % of the reused thermoplastic polymer powder.

Example 24. The system of any one of Examples 21 to 23, wherein the thermoplastic polymer powder comprises one or more of the following: a polyamide, polyoxymethylene (POM), polyaryletherketone (PAEK), polyether ether ketone (PEEK), polyetherketoneketone (PEKK), polybutylene terephthalate (PBT), polypropylene (PP), polycarbonate (PC), polysulfone, polyethylene (PE), or polymethyl methacrylate (PMMA).

Example 25. The system of any one of Examples 21 to 24, wherein the thermoplastic polymer powder is composed of a polymer having a number average molecular weight within a range from 100 kDa to 500 kDa.

Example 26. The system of any one of Examples 21 to 25, wherein the thermoplastic polymer powder has a particle size distribution having a span within a range from 0.5 to 1.

Example 27. The system of any one of Examples 21 to 26, wherein the thermoplastic polymer powder has one or more of the following: a melting temperature within a range from 100° C. to 220° C., a crystallization temperature within a range from 100° C. to 200° C., a glass transition temperature within a range from 30° C. to 170° C., or a degradation temperature within a range from 270° C. to 500° C.

Example 28. The system of Example 27, wherein the energy is configured to heat the thermoplastic polymer powder to a temperature below the melting temperature.

Example 29. The system of Example 27 or 28, wherein the energy is configured to heat the thermoplastic polymer powder to a temperature above the crystallization temperature.

Example 30. The system of any one of Examples 27 to 29, wherein the energy is configured to heat the thermoplastic polymer powder to a temperature below the degradation temperature.

Example 31. The system of any one of Examples 21 to 30, wherein the thermoplastic polymer powder comprises a flow agent.

Example 32. The system of Example 31, wherein the flow agent comprises a silica-based material, a calcium-based material, magnesium stearate, or a combination thereof.

Example 33. The system of Example 31 or 32, wherein the at least one flow agent constitutes up to 5 wt % of the thermoplastic polymer powder.

Example 34. The system of any one of Examples 21 to 33, wherein the additively manufactured palatal expander has one or more of the following: a tensile modulus within a range from 900 MPa to 3000 MPa, a dry flexural modulus within a range from 500 MPa to 2000 MPa, a wet flexural modulus within a range from 50 MPa to 300 MPa, or a storage modulus within a range from 1400 MPa to 3000 MPa.

Example 35. The system of any one of Examples 21 to 34, wherein the additively manufactured palatal expander comprises:
a first tooth engagement portion configured to receive one or more first teeth at a first side of a dental arch of a patient,
a second tooth engagement portion configured to receive one or more second teeth at a second side of the dental arch, and
a palatal portion between the first and second tooth engagement portions, wherein the palatal portion is configured to apply forces to the first and second tooth engagement portions to expand a palate of the patient.

Example 36. The system of any one of Examples 21 to 35, wherein the additively manufactured palatal expander is one of a series of a palatal expanders configured to incrementally expand a palate of a patient.

Example 37. A method comprising:
forming a mixture comprising a first thermoplastic polymer powder separated from a first additively manufactured dental appliance manufactured during a first powder bed fusion process, wherein the first thermoplastic polymer powder has a characteristic particle size distribution and a characteristic melt volume rate; and
in a second powder bed fusion process, depositing a powder layer of the mixture comprising the first thermoplastic polymer powder, wherein the powder layer has a powder packing consistency dependent on the characteristic particle size distribution of the first thermoplastic polymer powder; and
in the second powder bed fusion process, applying energy to the powder layer of the thermoplastic polymer powder to melt the powder layer of the mixture of thermoplastic polymer powder to form a part layer of a second additively manufactured dental appliance, wherein the part layer has a material consistency dependent on the characteristic melt volume rate of the first thermoplastic polymer powder.

Example 38. The method of Example 37, wherein the characteristic particle size distribution of the first thermoplastic polymer powder causes packing of particles in the powder layer such that the powder packing consistency is maximized.

Example 39. The method of Example 37 or 38, wherein the characteristic melt volume rate of the first thermoplastic polymer powder facilitates controlled distribution of the energy within the powder layer such that the material consistency is maximized.

Example 40. The method of any one of Examples 37 to 39, wherein the characteristic particle size distribution comprises a D90 value within a range from 70 micrometers (μm) to 150 μm, a D50 value within a range from 45 μm to 70 μm, and a D10 value within a range from 20 μm to 45 μm.

Example 41. The method of any one of Examples 37 to 40, wherein the characteristic melt volume rate is within a range from 30 cubic centimeters (cm³)/10 minutes (min) to 150 cm³/10 min.

Example 42. The method of any one of Examples 37 to 41, wherein the first additively manufactured dental appliance comprises an additively manufactured palatal expander shaped to expand a palate to a first palatal arrangement, the second additively manufactured dental appliance comprises an additively manufactured palatal expander shaped to expand a palate to a second palatal arrangement, or a combination thereof.

Example 43. The method of any one of Examples 37 to 42, wherein the first additively manufactured dental appliance and the second additively manufactured dental appliance are each part of a respective plurality of additively manufactured incremental palatal expanders to expand a palate in accordance with a plurality of stages of a respective treatment plan.

Example 44. The method of any one of Examples 37 to 43, wherein the first additively manufactured dental appliance, the second additively manufactured dental appliance, or a combination thereof, comprises:
a first tooth engagement portion configured to receive one or more first teeth at a first side of a dental arch of a patient,
a second tooth engagement portion configured to receive one or more second teeth at a second side of the dental arch, and
a palatal portion between the first and second tooth engagement portions, wherein the palatal portion is configured to apply forces to the first and second tooth engagement portions to expand a palate of the patient.

Example 45. The method of any one of Examples 37 to 44, wherein the first powder bed fusion process comprises a selective laser sintering (SLS) process, the second powder bed fusion process comprises an SLS process, or a combination thereof.

Example 46. The method of any one of Examples 37 to 45, wherein the mixture comprises the first thermoplastic polymer powder and a second thermoplastic polymer powder, and wherein the second thermoplastic polymer powder has not been used in a powder bed fusion process.

Example 47. The method of Example 46, wherein the first thermoplastic powder comprises at least 50 wt % of the mixture.

Example 48. The method of Example 46 or 47, wherein the first thermoplastic polymer powder, the second thermoplastic polymer powder, or a combination thereof, comprises one or more of the following: a polyamide, polyoxymethylene (POM), polyaryletherketone (PAEK), polyether ether ketone (PEEK), polyetherketoneketone (PEKK), polybutylene terephthalate (PBT), polypropylene (PP), polycarbonate (PC), polysulfone, polyethylene (PE), or polymethyl methacrylate (PMMA).

Example 49. The method of any one of Examples 46 to 48, wherein the first thermoplastic polymer powder, the second thermoplastic polymer powder, or a combination thereof, comprises one or more of the following: a melting temperature within a range from 100° C. to 220° C., a crystallization temperature within a range from 100° C. to 200° C., a glass transition temperature within a range from 30° C. to 170° C., or a degradation temperature within a range from 270° C. to 500° C.

Example 50. The method of any one of Examples 46 to 49, wherein the first powder bed fusion process, the second powder bed fusion process, or a combination thereof, comprises selectively heating the mixture to a temperature below a melting temperature of the first thermoplastic polymer powder, the second thermoplastic polymer powder, or a combination thereof.

Example 51. The method of any one of Examples 46 to 50, wherein the first powder bed fusion process, the second powder bed fusion process, or a combination thereof, comprises selectively heating the mixture to a temperature above a crystallization temperature of the first thermoplastic polymer powder, the second thermoplastic polymer powder, or a combination thereof.

Example 52. The method of any one of Examples 46 to 51, wherein the mixture is maintained below a degradation temperature of the first thermoplastic powder, the second thermoplastic powder, or a combination thereof during the first powder bed fusion process, the second powder bed fusion process, or a combination thereof.

Example 53. The method of any one of Examples 37 to 52, wherein the mixture comprises at least one flow agent.

Example 54. The method of any one of Examples 37 to 53, wherein the comprises at least one flow agent, and wherein the at least one flow agent comprises a silica-based material, a calcium-based material, magnesium stearate, or a combination thereof.

Example 55. The method of any one of Examples 37 to 54, wherein the mixture comprises at least one flow agent, and wherein the at least one flow agent constitutes up to 5 wt % of the mixture.

Example 56. The method of any one of Examples 37 to 55, further comprising fabricating the first additively manufactured dental appliance.

Example 57. A system comprising:
a mixer operative to form a mixture of thermoplastic polymer powder comprising:
   a first thermoplastic polymer powder separated from a first additively manufactured dental appliance manufactured during a first powder bed fusion process, wherein the first thermoplastic polymer powder has a characteristic particle size distribution and a characteristic melt volume rate, and
   a second thermoplastic polymer powder; and
a powder bed fusion system operative to fabricate a second additively manufactured dental appliance via a second powder bed fusion process, the powder bed fusion system comprising:
   a build platform;
   a material source operative to deposit a powder layer of the mixture of thermoplastic polymer powder on the build platform, wherein the powder layer has a powder packing consistency dependent on the characteristic particle size distribution of the first thermoplastic polymer powder; and
   an energy source operative to apply energy to the powder layer of the mixture of thermoplastic polymer powder to melt the powder layer of the mixture of thermoplastic polymer powder into a part layer of the second additively manufactured dental appliance, wherein the part layer has a material consistency dependent on the characteristic melt volume rate of the first thermoplastic polymer powder.

Example 58. The system of Example 57, wherein the characteristic particle size distribution of the first thermoplastic polymer powder causes packing of particles in the powder layer such that the powder packing consistency is maximized.

Example 59. The system of Example 57 or 58, wherein the characteristic melt volume rate of the first thermoplastic polymer powder facilitates controlled distribution of the energy within the powder layer such that the material consistency is maximized.

Example 60. The system of any one of Examples 57 to 59, wherein the characteristic particle size distribution comprises a D90 value within a range from 70 micrometers (μm) to 150 μm, a D50 value within a range from 45 μm to 70 μm, and a D10 value within a range from 20 μm to 45 μm.

Example 61. The system of any one of Examples 57 to 60, wherein the characteristic melt volume rate is within a range from 30 cubic centimeters (cm³)/10 minutes (min) to 150 cm³/10 min.

Example 62. The system of any one of Examples 57 to 61, wherein the first additively manufactured dental appliance comprises an additively manufactured palatal expander shaped to expand a palate to a first palatal arrangement, the second additively manufactured dental appliance comprises an additively manufactured palatal expander shaped to expand a palate to a second palatal arrangement, or a combination thereof.

Example 63. The system of any one of Examples 57 to 62, wherein the first additively manufactured dental appliance and the second additively manufactured dental appliance are each part of a respective plurality of additively manufactured incremental palatal expanders to expand a palate in accordance with a plurality of stages of a respective treatment plan.

Example 64. The system of any one of Examples 57 to 63, wherein the first additively manufactured dental appliance, the second additively manufactured dental appliance, or a combination thereof, comprises:
a first tooth engagement portion configured to receive one or more first teeth at a first side of a dental arch of a patient,
a second tooth engagement portion configured to receive one or more second teeth at a second side of the dental arch, and
a palatal portion between the first and second tooth engagement portions, wherein the palatal portion is configured to apply forces to the first and second tooth engagement portions to expand a palate of the patient.

Example 65. The system of any one of Examples 57 to 64, wherein the first powder bed fusion process comprises a selective laser sintering (SLS) process, the second powder bed fusion process comprises an SLS process, or a combination thereof.

Example 66. The system of any one of Examples 57 to 65, wherein the second thermoplastic polymer powder has not been used in a powder bed fusion process.

Example 67. The system of any one of Examples 57 to 66, wherein the first thermoplastic polymer powder comprises at least 50 wt % of the mixture.

Example 68. The system of any one of Examples 57 to 67, wherein the first thermoplastic polymer powder, the second thermoplastic polymer powder, or a combination thereof, comprises one or more of the following: a polyamide, polyoxymethylene (POM), polyaryletherketone (PAEK), polyether ether ketone (PEEK), polyetherketoneketone (PEKK), polybutylene terephthalate (PBT), polypropylene (PP), polycarbonate (PC), polysulfone, polyethylene (PE), or polymethyl methacrylate (PMMA).

Example 69. The system of any one of Examples 57 to 68, wherein the first thermoplastic polymer powder, the second thermoplastic polymer powder, or a combination thereof, comprises one or more of the following: a melting temperature within a range from 100° C. to 220° C., a crystallization temperature within a range from 100° C. to 200° C., a glass transition temperature within a range from 30° C. to 170° C., or a degradation temperature within a range from 270° C. to 500° C.

Example 70. The system of any one of Examples 57 to 69, wherein the first powder bed fusion process, the second powder bed fusion process, or a combination thereof, comprises selectively heating the mixture to a temperature below a melting temperature of the first thermoplastic polymer powder, the second thermoplastic polymer powder, or a combination thereof.

Example 71. The system of any one of Examples 57 to 70, wherein the first powder bed fusion process, the second powder bed fusion process, or a combination thereof, comprises selectively heating the mixture to a temperature above a crystallization temperature of the thermoplastic polymer powder, the second thermoplastic polymer powder, or a combination thereof.

Example 72. The system of any one of Examples 57 to 71, wherein the powder bed fusion system further comprising a temperature regulator operative to maintain the mixture of thermoplastic polymer powder is maintained below a degradation temperature of the first thermoplastic polymer powder, the second thermoplastic polymer powder, or a combination thereof during the second powder bed fusion process.

Example 73. The system of any one of Examples 57 to 72, wherein the mixture of thermoplastic polymer powder comprises at least one flow agent.

Example 74. The system of any one of Examples 57 to 73, wherein the mixture of thermoplastic polymer powder comprises at least one flow agent, and wherein the at least one flow agent comprises a silica-based material, a calcium-based material, magnesium stearate, or a combination thereof.

Example 75. The system of any one of Examples 57 to 74, wherein the mixture of thermoplastic polymer powder comprises at least one flow agent, and wherein the at least one flow agent constitutes up to 5 wt % of the mixture of thermoplastic polymer powder.

Example 76. The system of any one of Examples 57 to 75, wherein the powder bed fusion system is operative to fabricate the first additively manufactured dental appliance using the first thermoplastic polymer powder.

Example 77. A system comprising:
means for mixing thermoplastic polymer powder comprising:
   first thermoplastic polymer powder separated from a first additively manufactured dental appliance manufactured during a first powder bed fusion process, wherein the first thermoplastic polymer powder has a characteristic particle size distribution and a characteristic melt volume rate; and
   second thermoplastic polymer powder; and
a powder bed fusion system operative to fabricate a second additively manufactured dental appliance via a second powder bed fusion process, the powder bed fusion system comprising:
   a build platform;
   a material source operative to deposit a powder layer of the mixture of thermoplastic polymer powder on the build platform, wherein the powder layer has a powder packing consistency dependent on the characteristic particle size distribution of the first thermoplastic polymer powder; and
   an energy source operative to apply energy to the powder layer of the mixture of thermoplastic polymer powder to melt the powder layer of the mixture of thermoplastic polymer powder into a part layer of the second additively manufactured dental appliance.

Example 78. A method comprising:
a step for mixing first thermoplastic polymer powder separated from a first additively manufactured dental appliance manufactured during a first powder bed fusion process, wherein the first thermoplastic polymer powder has a characteristic particle size distribution and a characteristic melt volume rate; and
in a second powder bed fusion process, depositing a powder layer of the mixture comprising the first thermoplastic polymer powder, wherein the powder layer has a powder packing consistency dependent on the characteristic particle size distribution of the first thermoplastic polymer powder; and
in the second powder bed fusion process, applying energy to the powder layer of the mixture of thermoplastic polymer powder to melt the powder layer of the mixture of thermoplastic polymer powder into a part layer of a second additively manufactured dental appliance, wherein the part layer has a material consistency dependent on the characteristic melt volume rate of the first thermoplastic polymer powder.

### CONCLUSION

Although many of the embodiments are described above with respect to systems, devices, and methods for fabricating palatal expanders, the technology is applicable to other applications and/or other approaches, such as fabricating and processing of other types of dental appliance or other types of additively manufactured objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-7.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
forming a mixture comprising a first thermoplastic polymer powder separated from a first additively manufactured dental appliance manufactured during a first powder bed fusion process, wherein the first thermoplastic polymer powder has a characteristic particle size distribution and a characteristic melt volume rate; and
in a second powder bed fusion process, depositing a powder layer of the mixture comprising the first thermoplastic polymer powder, wherein the powder layer has a powder packing consistency dependent on the characteristic particle size distribution of the first thermoplastic polymer powder; and
in the second powder bed fusion process, applying energy to the powder layer of the thermoplastic polymer powder to melt the powder layer of the mixture of thermoplastic polymer powder to form a part layer of a second additively manufactured dental appliance, wherein the part layer has a material consistency dependent on the characteristic melt volume rate of the first thermoplastic polymer powder.

2. The method of claim 1, wherein the characteristic particle size distribution of the first thermoplastic polymer powder causes packing of particles in the powder layer such that the powder packing consistency is maximized.

3. The method of claim 1, wherein the characteristic melt volume rate of the first thermoplastic polymer powder facilitates controlled distribution of the energy within the powder layer such that the material consistency is maximized.

4. The method of claim 1, wherein the characteristic particle size distribution comprises a D90 value within a range from 70 micrometers (μm) to 150 μm, a D50 value within a range from 45 μm to 70 μm, and a D10 value within a range from 20 μm to 45 μm.

5. The method of claim 1, wherein the characteristic melt volume rate is within a range from 30 cubic centimeters (cm³)/10 minutes (min) to 150 cm³/10 min.

6. The method of claim 1, wherein the first additively manufactured dental appliance comprises an additively manufactured palatal expander shaped to expand a palate to a first palatal arrangement, the second additively manufactured dental appliance comprises an additively manufactured palatal expander shaped to expand a palate to a second palatal arrangement, or a combination thereof.

7. The method of claim 1, wherein the first additively manufactured dental appliance and the second additively manufactured dental appliance are each part of a respective plurality of additively manufactured incremental palatal expanders to expand a palate in accordance with a plurality of stages of a respective treatment plan.

8. The method of claim 1, wherein the first additively manufactured dental appliance, the second additively manufactured dental appliance, or a combination thereof, comprises:
a first tooth engagement portion configured to receive one or more first teeth at a first side of a dental arch of a patient,
a second tooth engagement portion configured to receive one or more second teeth at a second side of the dental arch, and
a palatal portion between the first and second tooth engagement portions, wherein the palatal portion is configured to apply forces to the first and second tooth engagement portions to expand a palate of the patient.

9. The method of claim 1, wherein the first powder bed fusion process comprises a selective laser sintering (SLS) process, the second powder bed fusion process comprises an SLS process, or a combination thereof.

10. The method of claim 1, wherein the mixture comprises the first thermoplastic polymer powder and a second thermoplastic polymer powder, and wherein the second thermoplastic polymer powder has not been used in a powder bed fusion process.

11. The method of claim 10, wherein the first thermoplastic powder comprises at least 50 wt % of the mixture.

12. The method of claim 10, wherein the first thermoplastic polymer powder, the second thermoplastic polymer powder, or a combination thereof, comprises one or more of the following: a polyamide, polyoxymethylene (POM), polyaryletherketone (PAEK), polyether ether ketone (PEEK), polyetherketoneketone (PEKK), polybutylene terephthalate (PBT), polypropylene (PP), polycarbonate (PC), polysulfone, polyethylene (PE), or polymethyl methacrylate (PMMA).

13. The method of claim 10, wherein the first thermoplastic polymer powder, the second thermoplastic polymer powder, or a combination thereof, comprises one or more of the following: a melting temperature within a range from 100° C. to 220° C., a crystallization temperature within a range from 100° C. to 200° C., a glass transition temperature within a range from 30° C. to 170° C., or a degradation temperature within a range from 270° C. to 500° C.

14. The method of claim 10, wherein the first powder bed fusion process, the second powder bed fusion process, or a combination thereof, comprises selectively heating the mixture to a temperature below a melting temperature of the first thermoplastic polymer powder, the second thermoplastic polymer powder, or a combination thereof.

15. The method of claim 10, wherein the first powder bed fusion process, the second powder bed fusion process, or a combination thereof, comprises selectively heating the mixture to a temperature above a crystallization temperature of the first thermoplastic polymer powder, the second thermoplastic polymer powder, or a combination thereof.

16. The method of claim 10, wherein the mixture is maintained below a degradation temperature of the first thermoplastic powder, the second thermoplastic powder, or a combination thereof during the first powder bed fusion process, the second powder bed fusion process, or a combination thereof.

17. The method of claim 1, wherein the mixture comprises at least one flow agent.

18. The method of claim 1, wherein the comprises at least one flow agent, and wherein the at least one flow agent comprises a silica-based material, a calcium-based material, magnesium stearate, or a combination thereof.

19. The method of claim 1, wherein the mixture comprises at least one flow agent, and wherein the at least one flow agent constitutes up to 5 wt % of the mixture.

20. The method of claim 1, further comprising fabricating the first additively manufactured dental appliance.
